(19) United States
(12) Patent Application Publication
(10) Pub. No.: US 2024/0420105 A1
(43) Pub. Date: Dec. 19, 2024

(54) NON-TRANSITORY STORAGE MEDIUM AND MANAGEMENT METHOD FOR REVIEW NFT EXECUTED IN ELECTRONIC COMMERCE

(71) Applicant: Tae Wook HWANG, Incheon (KR)

(72) Inventor: Tae Wook HWANG, Incheon (KR)

(21) Appl. No.: 18/817,376

(22) Filed: Aug. 28, 2024

Related U.S. Application Data
(63) Continuation of application No. PCT/KR2023/002825, filed on Feb. 28, 2023.

(30) Foreign Application Priority Data
Feb. 28, 2022 (KR) 10-2022-0025672

(51) Int. Cl. G06Q 20/12; G06Q 20/40; G06Q 30/0201

(52) U.S. Cl. CPC G06Q 20/123; G06Q 20/407; G06Q 30/0206; G06Q 2220/00

(57) ABSTRACT

A management method for a review non-fungible token (NFT), performed by a computing apparatus, according to an embodiment of the present disclosure, comprises the steps of: receiving, by a platform server, via a social network, a search request for goods or services to be traded; loading. by the platform server, a review NFT for the goods to be traded; loading, by the platform server, an order system connected to the review NFT; upon receiving a purchase request via the loaded order system, identifying and tracking, by the platform server, information of an owner of the review NFT; providing, by the platform server, a reward to the owner of the review NFT.

### CROSS-REFERENCE TO RELATED APPLICATION(S)

This application is a continuation of PCT Patent Application No. PCT/KR2023/002825, filed Feb. 28, 2023, by HWANG, entitled “NON-TRANSITORY STORAGE MEDIUM AND MANAGEMENT METHOD FOR REVIEW NFT EXECUTED IN ELECTRONIC COMMERCE,” which claims priority to Korean Patent Application No. 10-2022-0025672, filed Feb. 28, 2022. All sections of the aforementioned application(s) are incorporated herein by reference in its entirety.

### FIELD OF THE DISCLOSURE

The present disclosure relates to a non-transitory storage medium and management method for a review non-fungible token (NFT) executed in electronic commerce. More particularly, the present disclosure is related to a technology that utilizes the characteristics of NFTs, which enable proof of originality and verification from an issuer to a current owner, to specify products and consumer evaluations of the product, and that links consumer-generated review NFTs with sales platforms to allow consumers to participate in a value creation process through the review NFTs.

### BACKGROUND

Recently, non-fungible tokens (NFTs) have gained significant attention due to their ability to prove ownership transactions on networks connected to the Internet. NFTs utilize a blockchain technology, but unlike existing virtual assets, they have the characteristic of assigning a separate unique identification value to digital assets, making the digital assets non-interchangeable. Since NFTs are based on blockchain, all related information such as ownership and sales history is stored on the blockchain. Accordingly, originality can be proven, and data such as owner information and transaction history cannot be falsified, ensuring integrity.

However, NFTs are currently not fully utilized and being utilized at a relatively limited technical level, such as they are used for the purpose of proving ownership of original digital content. Therefore, there is a demand for developing technologies that can actively utilize NFTs in various transaction situations.

Consignment sales through existing e-commerce platforms connect sellers and consumers via dedicated e-commerce platforms. In this process, consumer review data plays an important role as a criterion for consumers to determine whether to purchase products and/or services traded on a certain e-commerce platform. Currently, in order to verify high-quality review data, platforms or sellers compensate consumers for writing reviews of products and/or services. Beyond this, there is a need to develop NFT technology that allows consumers to receive contribution profits for future transactions generated through the review writing.

### SUMMARY

The present disclosure is directed to providing a non-temporary storage medium and management method for a review non-fungible token (NFT) executed in electronic commerce. Specifically, the present disclosure is directed to providing a technology that utilizes the characteristics of NFTs, which enable proof of originality and verification from the issuer to the current owner, to specify products and consumer evaluations of the products, and that links consumer-generated review NFTs with sales platforms to allow consumers to participate in the value creation process through the review NFTs.

One aspect of the present disclosure provides a management method for a review NFT performed by a computing device according to one embodiment of the present disclosure, which includes: receiving, by a platform server via a social network, a search request for goods or services to be traded; loading, by the platform server, a review NFT for the goods or services to be traded; loading, by the platform server, an order system connected to the review NFT; when a purchase request is received via the loaded order system, at the platform server, identifying an owner of the review NFT and tracking information of the owner of the review NFT; providing, by the platform server, the owner of the review NFT with a pre-set reward for the review NFT; generating, by a user, a review NFT for purchased goods or services to be traded; and minting the review NFT on a blockchain network.

In one embodiment, the generating of the review NFT includes generating a preliminary review NFT before purchasing the goods or services to be traded.

In one embodiment, the preliminary review NFT may include physical attribute data and benefit data (or convenient data) of the goods or services to be traded.

In one embodiment, the generating of the review NFT includes generating a middle review NFT after the purchase of the goods or services to be traded is completed.

In one embodiment, the middle review NFT may include characteristic data for the goods or services to be traded.

In one embodiment, the generating of the review NFT includes generating a subsequent review NFT after an additional purchasing for the same goods or services is made. The management method may further include generating a subsequent review NFT when an additional transaction for the same good or service is made after a transaction for the same good or service to be traded has been completed.

In one embodiment, the subsequent review NFT may include an amount of consumption and price data for the goods or services to be trade in the additional purchasing.

In one embodiment, the generating of the review NFT may include if a preliminary review NFT, a middle review NFT, and a subsequent review NFT are generated, sequentially in order of generation time of each review NFT, Connecting the generated NFTs to each other through a side-chain.

In one embodiment, the management method may further include re-establishing the connection between the review NFT and the platform server when the user repurchases the same good or service after the cancellation on the blockchain network.

Another aspect of the present disclosure provides a non-transitory storage medium storing a program code according to one embodiment of the present disclosure, wherein the program code is executed by a hardware processor, and the program code is executed to enable generation and update of an NFT including review data in e-commerce performed on a blockchain network.

The program code may be executed, through the hardware processor, at a first consumer node, to generate a preliminary NFT including review data for the first product, before purchasing a first product sold by a first seller node, at a first consumer node, to generate a middle NFT including the review data for the first product after the purchase for the first product sold by the first seller node is completed, at the first consumer node, generate a subsequent review NFT including the review data for the first product when a repurchase for the first product sold by the first seller node; and provide the owner of at least one of the NFTs with a preset reward for the owner of the NFT when a second consumer node connects to at least one NFT of the preliminary NFT, the middle NFT, and the subsequent NFT and purchases the first product.

In one embodiment, the program code may be executed through the hardware processor to connect the generated NFTs to each other through a side-chain, if a preliminary review NFT, a middle review NFT, and a subsequent review NFT are generated, sequentially in order of generation time of each review NFT.

In one embodiment, the preliminary NFT may include physical attribute data and benefit data of the goods or services to be traded, the middle NFT may include characteristic data for the goods or services to be traded, and the subsequent NFT may include consumption amount and price data.

In one embodiment, the program code may be executed through the hardware processor to cause the second consumer node to generate a separate review NFT for the first product and propagate the generated separate review NFT to a blockchain network.

### Advantageous Effects

In the present disclosure, a blockchain and an NFT may be introduced in a consignment sales method of e-commerce, and in particular, by linking a consumer-created review NFT with a platform server, an active reward for a consumer review NFT may be possible.

When a user identifies a consumer review NFT through the platform server and determines to make a transaction based on the review NFT, the owner of the review NFT may be tracked and a reward may be returned to the owner, so that consumers can contribute as participants in future transactions through the generation of the review NFT and be motivated to produce high-quality reviews. In addition, consumers who participate in subsequent transactions may also become creators of review NFTs, allowing sellers and consumers, who are the main entities in the transaction, to generate review NFTs and create value through the generated NFTs, moving away from the existing system centrally managed by platform management entities

### BRIEF DESCRIPTION OF THE DRAWINGS

Reference will now be made to the accompanying drawings, which are not necessarily drawn to scale, and wherein:

FIG. 1 is a diagram illustrating an entity performing a management method for a review NFT performed by a computing device according to the present disclosure.

FIG. 2 is a diagram illustrating an example of a transaction of major nodes performing e-commerce on a blockchain network where a program code according to one embodiment of the present disclosure is executed.

FIG. 3 is a diagram illustrating nodes according to FIG. 2 in more detail.

FIG. 4 is a diagram illustrating an example of a transaction of major nodes performing e-commerce on a blockchain network where a program code according to another embodiment of the present disclosure is executed.

FIG. 5 is a flowchart illustrating a management method for a review NFT performed by a computing device according to one embodiment.

FIG. 6 is a flowchart illustrating a management method for a review NFT performed by a computing device according to another embodiment.

FIG. 7 is a flowchart illustrating a management method for a review NFT performed by a computing device according to still another embodiment.

FIG. 8 is a flowchart illustrating a management method for a review NFT performed by a computing device according to yet another embodiment.

### DETAILED DESCRIPTION

Hereinafter, with reference to the attached drawings, embodiments of the present disclosure will be described in detail so that a person having ordinary skill in the art to which the present disclosure pertains can carry out the embodiments. The present disclosure may be implemented in various different forms and is not limited to the embodiments described herein.

The present disclosure provides a non-temporary, non-transitory storage medium and a management method for an NFT in which consignment sales are performed in the form of e-commerce based on real-use reviews of consumers using the NFT without the need for an intermediate e-commerce platform. According to the present disclosure, when a user identifies a consumer review NFT through a platform server and determines to make a transaction based on the review NFT, the owner of the review NFT may be tracked and a reward may be returned to the owner, so that consumers can contribute as participants in future transactions through the generation of the review NFT and be motivated to produce high-quality reviews.

In this specification, a non-fungible token (NFT) is a digital asset with scarcity. Since the NFT is based on a blockchain technology, all related information, such as ownership and sales history, is stored on the blockchain, so that originality can be proven, and data such as owner information and transaction history cannot be falsified, ensuring integrity.

Since the metadata and information of the digital asset are distributed and stored among participating nodes through the blockchain network, tampering is impossible, and all transaction details from the initial issuer to the current owner can be tracked.

Review NFTs can be used to prove the owner of a review of goods or services by the characteristics of the aforementioned NFTs. The owner of the review can be the original creator of the review. In the present disclosure, the review NFT is directly generated by the consumer, and is intended to induce the consumer not only to consume the product but also to participate directly in sales based on the information generated after consumption. To analyze and predict consumer behavior, the present disclosure can be concretized based on the following consumer behavior theories. The consumer behavior theory is implemented through transactions via review NFTs.

Specifically, the basic model of consumer behavior may be concretized by the stimulus (input), the response (output), and the parameters connecting them.

The stimulus model of consumer behavior may be divided into the four core items of product, price, route, and promotion, as well as other stimulus elements of economic factors, technological factors, policy factors, and cultural factors. The response (output) may correspond to the consumer response such as product selection, brand selection, purchase time, and price. The parameters refer to the consumer's decision-making process, corresponding to the consumer's black box where decisions are made based on consumer characteristics.

The consumer's decision-making process for product purchase is determined by i) problem recognition, ii) information search, iii) alternative evaluation attitude formation, iv) purchase, v) post-purchase evaluation, and vi) satisfaction/dissatisfaction, and memory information about satisfaction/dissatisfaction acts as an internal factor in the information search. In addition, exposed information may act as an external factor in the information search.

However, in the purchase decision-making process, iii) alternative evaluation attitude formation is applied only when the goods or services to be traded are high-involvement products, and attitude formation may not be applied when the goods or services to be traded are low-involvement products.

The consumer's purchase alternative evaluation model may be based on the Fishbein multi-attribute attitude model and the theory of reasoned action of Fishbein.

The Fishbein multi-attribute attitude model is described by the following mathematical equation.

$${A}_{0} = {\sum }_{i = 1}^{n} {b}_{i} \cdot {e}_{i}$$

People's attitudes toward an object are composed of their beliefs about various attributes of the object and implicit evaluation related to those attributes.

The belief about attributes is information and opinions that consumers have about the product's attributes, which represent their personal thoughts about those attributes.

Evaluation of attributes indicates how much each attribute contributes to satisfying consumers' needs, and the evaluation of each attribute of a product plays a role in the importance (evaluation value) of the attribute in forming the overall attitude.

Fishbein's theory may be extended to the theory of reasoned action. The extended Fishbein theory states that the personal factor (A) that influences purchase behavior intention is not “attitude toward the object” but “attitude toward the behavior related to the object.” In this extended Fishbein model, an individual's attitude is composed of their belief (bi) about the outcomes of the behavior and their evaluation (Ei) of those outcomes.

Total utility is the total amount of subjective satisfaction that can be obtained by consuming goods. (Total utility=L marginal utility).

Marginal utility (MU) is the additional satisfaction obtained when the amount of consumption of goods increases by one unit, representing an increase in the total utility.

When the amount of consumption of goods exceeds a certain amount, marginal utility decreases, which is called the law of diminishing marginal utility. In marginal utility theory, the law of diminishing marginal utility is assumed to be a general phenomenon.

The following mathematical equation describes the law of marginal utility equilibrium per won and corresponds to the equilibrium condition.

$$\frac{{MU}_{x}}{{P}_{x}} = \frac{{MU}_{y}}{{P}_{y}} = m$$

In the equilibrium, if Pₓ decreases, it becomes

$$\frac{{MU}_{x}}{{P}_{x}} > \frac{{MU}_{y}}{{P}_{y}} ,$$

the utility of 1 won worth of good X is greater than the utility of 1 won worth of good Y. Therefore, consumers may increase their purchase of good X and decrease their purchase of good Y.

Since consumers will only purchase goods that provide higher satisfaction than the amount they pay when purchasing goods, exchange through the market brings benefits to the consumers. The benefits that consumers gain through market transactions are called consumer surplus.

This consumer surplus is defined in this specification as “a difference between the maximum amount that a consumer is willing to pay to purchase a certain good and the actual amount paid.”

Therefore, from the perspective of consumer surplus theory, when a user writes an NFT review after purchasing a good or service, the consumer surplus will be expressed as a positive value for gains and a negative value for losses. In addition, this information can be evaluated as equilibrium-complementary for third-party consumers.

Variables that determine the final size of the consumer surplus include the amount of consumption and the slope of the price-demand curve. In particular, the amount of consumption and price are representative variables that are appropriate for explaining the user's consumer surplus, and in this specification, these variables are included as data for the additional review NFT.

TABLE 1

| Importance for each | | Evaluation of each brand (bi) | |
|---|---|---|---|
| attribute (ei) | | NFT #101 red dress | NFT #201 white dress |
| Economic (i) | 40 | 3 | 8 |
| Style (i) | 60 | 5 | 5 |

| | | |
|---|---|---|
| Evaluation score | 420 | 620 |
| (attitude score) | | |

Table 1 shows an example that a consumer evaluates physical attributes to evaluate purchase alternatives when during the consumer's purchase decision-making process. The purchase decision-making process is performed before purchasing for the product (goods).

For example, a user may evaluate the physical attributes of a product, such as color (red and white), and when there is an evaluation value such as the existence of a promotion for white products even if the evaluation values for style are similar, the user may evaluate the economic feasibility of white products higher. Furthermore, when a consumer evaluates benefits, this involves making various decisions based on not only the physical properties of the product but also the consumer's preferences, usage, etc.

For example, even if the white dress is economically advantageous, a consumer may evaluate benefits such as choosing the red dress for a gathering due to its higher attention-grabbing quality, regardless of price.

Next, after the purchase is completed with the evaluation, the actual goods and services may be evaluated. For example, a red dress may be evaluated to have a darker red color and a more luxurious material when actually purchased.

Finally, the evaluation on consumer surplus may include positive and negative evaluations of goods and services based on reviews of products purchased by users.

These consumer evaluations are based on Fishbein's multi-attribute model and theory of reasoned action, and the consumer's purchase decision-making process and attitude determination process are largely divided into 1) attitude toward an object based on physical attributes and 2) attitude toward behavior related to the object. This division may also be interpreted as being divided into objectivity and subjectivity.

In the present disclosure, the concept of evaluation (or review) that is the subject of the review NFT is divided into 1) attitude toward the object based on physical attributes and 2) attitude toward behavior related to the object, and may include different types of data depending on the time of generation of the NFT.

Hereinafter, a configuration of the present disclosure will be described in detail with the accompanying drawings.

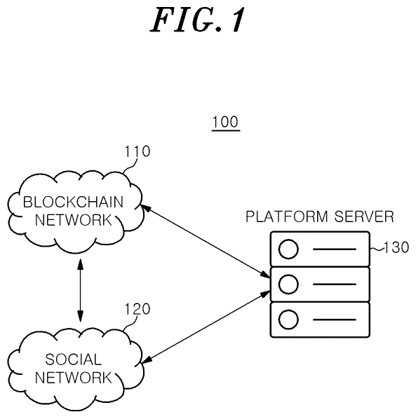

FIG. 1 is a diagram illustrating an entity performing a management method for a review NFT performed by a computing device according to the present disclosure. Referring to FIG. 1, a review NFT system 100 may include a blockchain network 110, a social network 120, and a platform server 130.

The review NFT system 100 may provide an environment that automatically connects a program code and an appropriate software and hardware execution environment required for executing the program code. That is, when the requirements for hardware that can execute the program code requested by the user are set, the review NFT system 100 may search for an optimal computer that satisfies the requirements among computers in which the platform server 130 systems and/or the blockchain network 110 systems are registered as nodes, and connect the optimal computer found through the search with the corresponding program code. In this manner, the procedure in which the program code is connected to a node on the blockchain network 110 system can be referred to as a “connection procedure,” and the blockchain network 110 system that provides this environment can be referred to as a “connection cloud.” In addition, since the program code that exists in a containerized form may be downloaded to the computer and executed immediately, the user may easily receive the execution result. Each node participating in the blockchain network 110 can perform calculations by including one or more processors.

The social network 120 may be a public network that users can generally access through a communication network such as the Internet for easy access to the user's goods and services to be traded. The user may find information on the goods and services to be traded, which is publicly disclosed through the social network 120. When the user wishes to trade the goods and services to be traded, the review NFT system 100 may load an order system that allows the user to trade the goods and services to be traded through the platform server 130, and when the user wishes to identify the review NFT for the goods and services to be traded, the review NFT information may be identified on the blockchain network 110.

This review NFT may be composed of NFT metadata and an NFT smart contract.

The NFT metadata may store URI information linked to a program code including ownership information of review data of goods subject to consignment sales, object information related to the characteristics of the review data of goods or services subject to consignment sales, and worker node address information with which the review data of goods or services subject to consignment sales can be executed.

Meanwhile, NFT media data linked to the NFT metadata may be code data of the review data of goods or services subject to consignment sales or preprocessed data for artificial intelligence learning, and may be data stored in an external storage or IPFS.

The NFT smart contract may receive a transaction containing the NFT metadata information, and issue (mint) the review data NFT of goods or services subject to consignment sales corresponding to the transaction. The NFT smart contract can be implemented in the form of a script for issuing a review data NFT.

Meanwhile, the NFT issued on the NFT smart contract may serve as a permanent identifier linked to a blockchain network address when the transaction is finally verified at a blockchain consensus node.

The platform server 130 may include all components for searching for a node having an execution environment for executing the program code on the blockchain network 110 and enabling the program code to be executed on the node, but is not limited to a specific example.

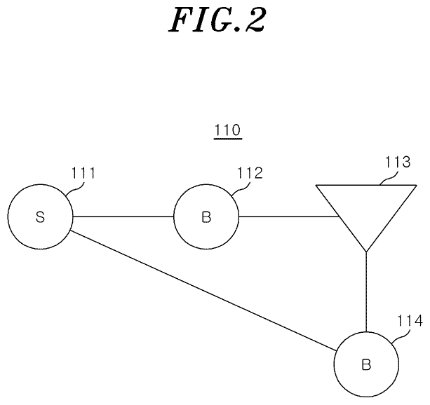

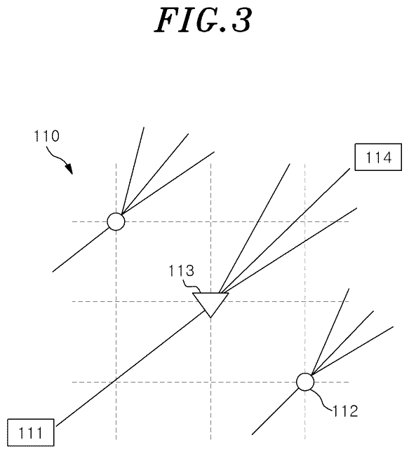

FIG. 2 is a diagram illustrating an example of a transaction of major nodes performing e-commerce on a blockchain network where a program code according to one embodiment of the present disclosure is executed. FIG. 3 is a diagram illustrating nodes according to FIG. 2 in more detail.

Referring to FIGS. 2 and 3, a plurality of nodes 111, 112, and 114 and an NFT 113 on the blockchain network 110 are exemplarily illustrated. The plurality of nodes 111, 112, 114 are computing devices that participate as nodes in the blockchain network 110.

The seller node 111 may sell goods or services to be traded according to a seller user. The first consumer node 112 may generate a middle review NFT 113 according to a first consumer user, after purchasing the goods or services to be traded. The generated middle review NFT 113 may be issued to the blockchain network 110. The third consumer node 114 may identify information on the goods or services to be traded, which is being sold by the seller node 111 through the middle review NFT 113. When the third consumer node 114 wants to purchase a product from the seller node 111 based on the middle review NFT 113, the platform server 130 of FIG. 1 may load an order system that allows the third consumer node 114 to trade the goods or services to be traded. When the third consumer node 114 completes the transaction through the order system, the platform server 130 of FIG. 1 provides a predetermined reward to the first consumer node 112 corresponding to the first consumer user, who is the owner of the middle review NFT 113.

The middle review NFT 113 connects review data and consumers using blockchain technology. The first consumer node 112 can purchase products through the middle review NFT 113 instead of a centralized platform. By way of example, the platform server 130 in FIG. 1 in the present disclosure corresponds to a server that implements a function to implement consignment sales through NFT, and is not a centralized platform, etc.

Referring to FIG. 3, the blockchain network 110 may make connections between the seller node 111 and the consumer node 112 and between the NFT 113 and the third consumer node 114, and may further promote the generation of the NFT of the third consumer node 114, so that each node of the blockchain, rather than the centralized platform, may perform the role of the platform. A purchase loss that occurs through the NFT may be offset by each consumer securing the profit through the generation of the NFT.

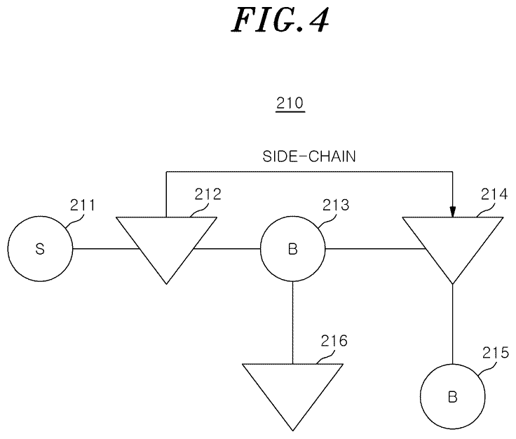

FIG. 4 is a diagram illustrating an example of a transaction of major nodes 211, 212, 213, 214, 215, and 216 performing e-commerce on the blockchain network 210 in which a program code according to another embodiment of the present disclosure is executed. Referring to FIG. 4, similarly to FIG. 3, the goods or services to be traded are sold from the seller node 211 to the consumer node 213, and the review NFTs 212, 214, and 216 are generated accordingly. A difference from FIG. 3 is that in FIG. 3, only the middle NFT (113 in FIG. 3) is generated, but in FIG. 4, depending on the generation time of the review NFT, a preliminary review NFT 212, a middle review NFT 214, and a subsequent review NFT 216 may be generated separately.

The preliminary review NFT 212 is an NFT generated during a purchase decision-making before purchasing for the goods or services to be traded. The preliminary review NFT 212 includes physical attribute data and benefit data of the goods or services to be traded. The physical attribute data of the goods or services is data describing a physical attribute of the goods or services, such as color. The benefit data of the goods or service is data describing the results of consumers' evaluations of services or goods as convenient or beneficial, such as evaluating values such as attention. Physical attribute data are related to objective influences on purchase decision-making, while benefit data are related to subjective influences on purchase decision-making. Since the meanings of the physical attribute data and benefit data have already been described above, redundant content will be omitted.

The preliminary review NFT 212 is generated through an NFT smart contract that has been previously distributed to the blockchain network 110. Let us assume that the first owner of the preliminary review NFT 212, i.e., the issuance requester, is the first consumer node 211. The first consumer node 211 initiates a transaction requesting the minting of the preliminary review NFT 212. This transaction includes a request for issuance of the preliminary review NFT 212 and the user input data to be included in the preliminary review NFT 212. The user input data consists of the physical property data and benefit data of the goods or services to be traded, which the user obtained at the purchase decision-making stage. The transaction is signed using the private key of the first consumer node 211. This signature verifies that the transaction originates from the user and ensures the integrity and authenticity of the transaction. The first consumer node 211 broadcasts the signed transaction to the blockchain network 111. The blockchain network 111 processes the signed transaction to issue the preliminary review NFT 212. Specifically, the blockchain network 111 verifies the transaction, which involves checking the validity of the user's digital signature, the appropriateness of the smart contract call, and whether the user has the authority to issue the NFT (e.g., sufficient funds or tokens). If the verification is successful, the blockchain network 111 executes the NFT smart contract. Upon execution of the NFT smart contract, the following series of processes occur: i) generating the preliminary review NFT 212, ii) storing the metadata of the preliminary review NFT 212, and iii) assigning ownership of the preliminary review NFT 212. Specifically, the NFT smart contract generates the preliminary review NFT 212 with a unique ID. The preliminary review NFT 212 includes the physical property data and benefit data provided by the user. The metadata of the generated preliminary review NFT 212 can either be stored on the blockchain or in decentralized storage outside the blockchain (e.g., IPFS (InterPlanetary File System)). In the latter case, only the storage location (e.g., reference link) of the decentralized storage for accessing the metadata is stored on the blockchain. The generated NFT is then assigned to the address of the first consumer node 211 that requested the issuance.

The issuance process of the preliminary review NFT 212 is recorded on the blockchain. Specifically, the blockchain network 111 generates a block that includes the verified transaction, which is then added to the existing blockchain and propagated across the blockchain network 111. Each node in the network receives this new block and appends it to its own copy of the blockchain. As a result, participants in the blockchain network 111 share the knowledge of the issuance of the preliminary review NFT 212. The middle review NFT 214 is an NFT generated after the purchase of the goods to be traded is completed, and includes characteristic data on the goods or services to be traded. Since the meaning thereof has already been described above, redundant content will be omitted.

The process of generating a middle review NFT 214 is also similar to the process of generating a the preliminary review NFT 212. The first consumer node 211 generates a transaction for issuing a middle review NFT 214, electronically signs it, and transmits the electronically signed transaction to the blockchain network 110. This transaction includes a request for issuing a middle review NFT 214 and user input data to be included in the middle review NFT 214. The user input data is characteristic data on the subject goods or services acquired by purchasing the subject goods or services. When receiving a transaction for the middle review NFT 214, the blockchain network 110 issues a middle review NFT through an NFT smart contract and records the issuance fact on the blockchain. Since the process for issuing (minting) a middle review NFT through an NFT smart contract and recording the issuance fact on the blockchain of the blockchain network 110 has been described above in the process of issuing a the preliminary review NFT 212, a detailed description thereof will be omitted.

The subsequent review NFT 216 is an NFT that is generated by an additional transaction. The additional transaction is a subsequent transaction that occurs after the previous transaction that caused the issuance of the middle review NFT for the same goods is completed.

The subsequent review NFT 216 is characterized by including consumption and price data for the product or service in the additional transaction. The consumption and price data of the subsequent review NFT 216 and the consumption and price data of the middle review NFT 214 may be the same or different depending on the transaction information. Since the meaning thereof has already been described above, redundant content is omitted. Further, the process of generating Subsequent review NFT 216 is similar to the process of generating the middle review NFT 214, so a detailed description is omitted.

In this case, the plurality of NFTs 212, 214, 216 with different IDs are issued for the same goods or services. Since the multiple NFTs including the preliminary review NFT 212, the middle review NFT 214, and the subsequent review NFT 216 are generated for the same goods or services, there is a problem that confusion occurs when the third consumer 215 tries to access the corresponding goods because the NFTs are dispersed. Therefore, the preliminary review NFT 212, the middle review NFT 214, and the subsequent review NFT 216 connect each other using a side-chain to efficiently manage the NFTs for the same goods or services in the present disclosure.

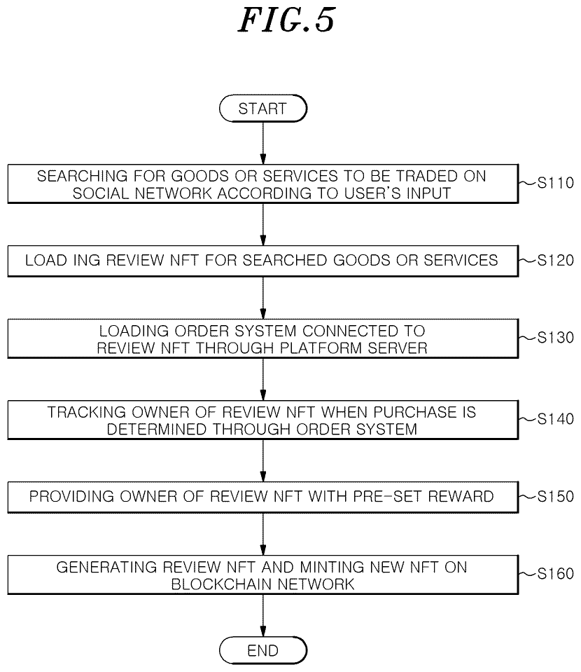

FIG. 5 is a flowchart illustrating a management method for a review NFT performed by a computing device according to one embodiment. Referring to FIG. 5, the management method may include searching for, goods or services to be traded on a social network according to user's input (S110); loading a review NFT for the searched goods or services (S120); loading an order system connected to the review NFT through a platform server (S130); tracking an owner of the review NFT for the goods or services when a purchase for the goods or services is determined through the order system (S140); providing a reward to the owner of the review NFT (S150); and generating, a review NFT for the goods or services and issuing (minting) a new NFT for the goods or services on a blockchain network according to user's input (S160).

Operation S110 may include searching for related information through a social network so that a consumer can easily search for goods or services to be traded, and receiving the search results. Existing centralized platforms often include product search, advertising, and product transaction functions on their own, but an e-commerce method using review NFTs according to the present disclosure utilizes a public network such as a social network through the product search function instead of going through the centralized platform.

In operation S120, the review NFT for the goods or services to be traded that the consumer has searched for may be loaded on the blockchain network, and the user may identify the utility-benefit of the consumer's consumption experience through review data included in the review NFT.

In operation S130, when the consumer is satisfied with the review NFT and wants to purchase a corresponding product, an order system connected to the review NFT may be loaded through the platform server and the product may be purchased, rather than purchasing the product from the platform itself like the centralized platform.

In operation S140, an owner of the review NFT may be tracked, and in operation S150, the owner (consumer) may be provided with a predetermined reward. Through these operations, the consumer is not a simple consumer, but belongs to a trading process that does not go through the centralized platform, and may also become a member who can carn additional profits as a creator of the review NFT.

When the consumer who purchased the product does not simply consume but wants to create a new review NFT, operation S160 may include creating a review NFT and issuing the created review NFT to the blockchain network.

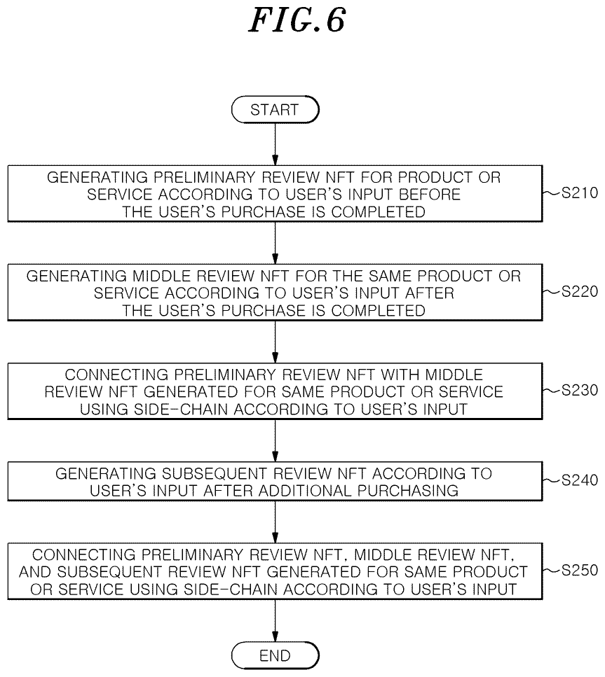

FIG. 6 is a flowchart illustrating a management method for a review NFT performed by a computing device according to another embodiment. Referring to FIG. 6, the management method may include operations of a user generating a preliminary review NFT when step of purchase decision-making (S210); the user generating a middle review NFT after the purchase (S220); the user connecting the preliminary review NFT and the middle review NFT generated for the same product or service using a side-chain (S230); the user generating a subsequent review NFT after additional consumption (S240); and the user connecting the preliminary review NFT, the middle review NFT, and the subsequent review NFT generated for the same product or service using the side-chain (S250).

In steps of S230, S250, the process of connecting another NFT to a side chain and the result thereof can be recorded on the blockchain of the blockchain network 110. The first consumer node 211 creates a transaction to connect to the side chain. The transaction includes a request for forming a side chain and information about an NFT to be connected to the side chain. In step of S230, the transaction includes the NFT IDs of each of the preceding review NFT 212 and the central review NFT 214. In step of S250, the transaction includes the NFT IDs of each of the preceding review NFT 212, the central review NFT 214, and the subsequent review NFT 216. The transaction is signed using the private key of the first consumer node 211. This signature verifies that the transaction originates from the user. The first consumer node 211 transmits the signed transaction to the blockchain network 110. The blockchain network 110 processes the signed transaction to connect the side chain. Specifically, the blockchain network 111 verifies the transaction. This involves verifying the user's digital signature, ensuring that the NFTs to be connected pertain to the same goods or services, and validating that the smart contract conditions for connecting the NFTs to a side chain are met. If the verification is successful, the blockchain network 110 connects the NFTs to a side chain.

The details of the side chain connection process, including the NFT IDs and the relationship between them, are recorded in the blockchain in S230, S250. The blockchain network 110 includes the verified transaction in a block, which is newly added to the existing blockchain after the transaction is verified and before the block is transmitted to the nodes. The blockchain network 110 transmits the created block to nodes in the blockchain network 110. Each node receives this new block and adds it to its own blockchain. As a result, participants in the blockchain network 110 share the knowledge that the side chain is connected.

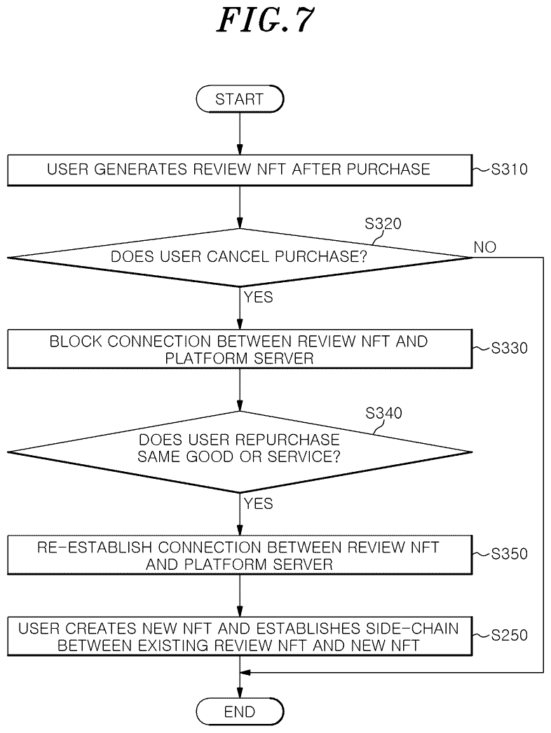

FIG. 7 is a flowchart illustrating a management method for a review NFT performed by a computing device according to still another embodiment. Referring to FIG. 7, the management method includes operations of a user generating a review NFT after a purchase (S310); determining whether the user cancels the purchase (S320); blocking a connection between the review NFT and a platform server when the purchase is canceled (S330); determining whether the user has repurchased the same good or service (S340); re-establishing the connection between the review NFT and the platform server when the repurchase has occurred (S350); and the user creating a new NFT and establishing a side-chain between the existing review NFT and the new NFT (S360).

Operation S320 may include determining whether a situation has occurred in which the user generated the review NFT after purchasing a product in the previous operation, but then canceled the product purchase and returned the product. When a person who did not ultimately purchase the product issues a review NFT, the purpose is only to secure profits through the review NFT, so no proper compensation is paid for the product. In addition, this case may reduce the reliability of the review data, and therefore separate management of this case is required.

In operation S330, when the cancellation is identified, the connection between the review NFT and the platform server is blocked, thereby prohibiting the consumer who wrote the review NFT from disclosing the review NFT to the outside or linking the review NFT with the order system to obtain compensation. However, the review NFT itself is not deleted or erased in this operation.

In operation S340, whether the user repurchases the goods and services for which the review NFT was written is determined. In the case of a purchase, there may be cases where the purchase is canceled and a repurchase occurs due to unavoidable circumstances, or it may be simply a change of mind by the consumer.

In operation S350, when the repurchase is identified, the connection relationship to reuse the previously generated review NFT is re-established. As mentioned above, there may be various reasons for cancellation of the purchase and repurchase. In such cases, if the previously generated review NFTs were discarded, it would be detrimental to both the seller and the consumer. Thus, it is easy to recycle the review NFTs by re-establishing the connection relationship of the previously written review NFTs.

In operation S360, when the consumer additionally generates a new review NFT, the new review NFT is issued and a side-chain between the NFTs for efficient management is built. The new review NFT is the subsequent review NFT 216 for goods or services that are being repurchased. Therefore, step S360 may involve the process of generating the subsequent review NFT 216, as described with reference to FIG. 4, and the process of connecting the subsequent review NFT 216 and existing review NFTs to a side chain, as detailed in step S250 in FIG. 6. Since each of these processes has already been described, further detailed explanation is omitted.

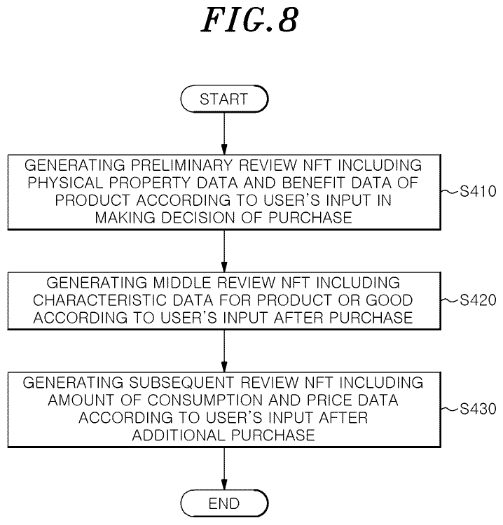

FIG. 8 is a flowchart illustrating a management method for a review NFT performed by a computing device according to yet another embodiment. Referring to FIG. 8, the management method may include generating, by a user, a preliminary review NFT including physical attribute data and benefit data of a product when step of purchase decision-making (S410); generating, by the user, a middle review NFT including characteristic data for a product or good after the purchase (S420); and generating, by the user, a subsequent review NFT after additional consumption, wherein the subsequent review NFT includes the amount of consumption and price data (S430).

In the generating of these NFTs (S410, S420, and S430), when the Fishbein theory and the theory of reasoned action are reflected as described above, 1) attitude toward the object based on physical property and 2) attitude toward behavior related to the object may include specific data depending on the time of generation of the NFTs. Thus, when the consumer purchases and reviews goods on the blockchain, it is possible to identify the main variables in terms of utility and benefits, and to manage and control efficient review NFTs according to the equilibrium-complementary model. However, this data management of the review NFTs is only an example and embodiments are not limited to this.

The method, operation, technique, etc., of the present disclosure are non-transitory storage media storing a program code, wherein the program code is executed by a hardware processor, and the program code is executed to enable the generation and update of a non-fungible token (NFT) including review data in an e-commerce transaction performed on a blockchain network. The program code may be executed, when a purchase intention for a first product sold by a first seller node is determined in a first consumer node through the hardware processor, to generate a preliminary NFT including review data for the first product, may be executed to generate a middle NFT including the review data for the first product after the purchase for the first product sold by the first seller node is completed in the first consumer node, may be executed to generate a subsequent NFT including the review data for the first product when a repurchase for the first product sold by the first seller node is made in the first consumer node, and may be executed to provide a predetermined reward to the owner of at least one of the NFTs when a second consumer node connects to at least one NFT of the preliminary NFT, the middle NFT, and the subsequent NFT, and purchases the first product.

The methods, operations, or techniques of the present disclosure may be implemented by various means. For example, these techniques may be implemented in hardware, firmware, software, or a combination thereof. Those skilled in the art will appreciate that the various exemplary logical blocks, modules, circuits, and algorithm steps described in connection with the disclosure herein may be implemented in electronic hardware, computer software, or a combination of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computers, or a combination thereof. In firmware and/or software implementations, the techniques may be implemented as instructions stored on a computer-readable medium, such as a random access memory (RAM), a read-only memory (ROM), a non-volatile random access memory (NVRAM), a programmable read-only memory (PROM), an erasable programmable read-only memory (EPROM), an electrically erasable PROM (EEPROM), a flash memory, a compact disc (CD), a magnetic or optical data storage device, etc. The instructions may be executable by one or more processors and may cause the processor(s) to perform certain aspects of the functionality described in the present disclosure.

When implemented in software, the techniques may be stored on computer-readable media or transmitted on computer-readable media as one or more instructions or code. Computer-readable media include both computer storage media and communication media, including any medium that facilitates transfer of a computer program from one place to another. The storage media may be any available media that can be accessed by a computer. By way of example, and not limitation, such computer-readable media may include a RAM, a ROM, an EEPROM, a CD-ROM or other optical disk storage, magnetic disk storage or other magnetic storage devices, or any other medium that can be used to carry or store certain program code in the form of instructions or data structures and that can be accessed by a computer. Also, any connection is properly termed a computer-readable medium.

This software module may reside in a RAM memory, a flash memory, a ROM memory, an EPROM memory, an EEPROM memory, registers, a hard disk, a removable disk, a CD-ROM, or any other form of storage medium known in the art. An exemplary storage medium can be coupled to the processor such that the processor can read information from and write information on the storage medium. Alternatively, the storage medium may be integral to the processor. The processor and the storage medium may reside in an ASIC. The ASIC may reside in a user terminal. Alternatively, the processor and the storage medium may reside as discrete components in a user terminal.

The above-described embodiments are combinations of elements and features of the present disclosure in specific forms. The elements or features may be considered selective unless mentioned otherwise. Each element or feature may be implemented without being combined with other elements or features. Further, the embodiments of the present disclosure may be configured by combining some of the elements and/or features. The order of operations described in the embodiments of the present disclosure may be rearranged. Several configurations or features of any one embodiment may be included in another embodiment or may be replaced with related configurations or features of another embodiment. It is obvious that claims that are not explicitly cited in the appended claims may be combined to form an embodiment or included as a new claim by amendment after filing.

Various embodiments of the present disclosure may be carried out in other specific ways than those set forth herein without departing from the essential characteristics of the present disclosure. The above implementations are therefore to be construed in all aspects as illustrative and not restrictive. The scope of the disclosure should be determined by the appended claims and their legal equivalents, not by the above description, and all changes coming within the meaning and equivalency range of the appended claims are intended to be included therein.

What is claimed is:

1. A management method for a review non-fungible token (NFT), performed by a computing apparatus, the management method comprising:
receiving, by a platform server via a social network, a search request for goods or services to be traded;
loading, by the platform server, a review NFT for the goods or services to be traded;
loading, by the platform server, an order system connected to the review NFT;
receiving, by the platform server, a purchase request via the loaded order system;
upon the receipt of the purchase request, identifying, by the platform server, an owner of the review NFT and tracking information of the owner of the review NFT;
providing, by the platform server, the owner of the review NFT with a pre-set reward for the review NFT; and
minting, by the platform server, the review NFT on a blockchain network.

2. The management method of claim 1, further including loading a preliminary review NFT before purchasing the goods or services to be traded.

3. The management method of claim 2, wherein the preliminary review NFT includes physical attribute data and benefit data of the goods or services to be traded.

4. The management method of claim 2, further including loading a middle review NFT after execution of the purchase request of the goods or services to be traded is completed.

5. The management method of claim 4, wherein the middle review NFT includes characteristic data for the goods or services to be traded.

6. The management method of claim 4, further including loading a subsequent review NFT after an additional purchasing for a same goods or services is made.

7. The management method of claim 6, wherein the subsequent review NFT includes an amount of consumption and price data for the goods or services to be trade in the additional purchasing.

8. The management method of claim 6, further comprising:
sequentially loading, by the platform server, in order of generation time of each review NFT including the preliminary review NFT, the middle review NFT, and the subsequent review NFT; and
connecting, by the platform server, the sequentially loaded review NFTs to each other through a side-chain on the blockchain network.

9. The management method of claim 1, further comprising:
determining, by the platform server, whether the purchase request has been canceled; and
upon the purchase request cancellation determination, blocking, by the platform server, a connection to the review NFT on the blockchain network.

10. The management method of claim 9, further comprising:
re-establishing, by the platform server, the connection between the review NFT and the platform server when receiving a request to repurchase a same good or service after the cancellation of the purchase request on the blockchain network.

11. A non-transitory storage medium storing a program code, the program code being executed by a hardware processor and to enable generation and update of an NFT including review data in e-commerce performed on a blockchain network,
wherein the program code is executed, through the hardware processor, to perform operations comprising:
at a first consumer node, generating a preliminary NFT including review data for a first product before purchasing the first product sold by a first seller node;
at the first consumer node, generating a middle NFT including the review data for the first product after the purchase for the first product sold by the first seller node is completed;
at the first consumer node, generating a subsequent review NFT including the review data for the first product when a repurchase for the first product sold by the first seller node; and
at the first consumer node, receiving a preset reward when a second consumer node connects to at least one NFT of the preliminary NFT, the middle NFT, and the subsequent NFT and executes a purchase request of the first product.

12. The non-transitory storage medium of claim 11, wherein the operations further comprise connecting the generated NFTs to each other through a side-chain on the blockchain network, sequentially in order of generation time of the preliminary NFT, the middle NFT, and the subsequent NFT.

13. The non-transitory storage medium of claim 11, wherein the preliminary NFT includes physical attribute data and benefit data of the first product, the middle NFT includes characteristic data for the first product, and the subsequent NFT include an amount of consumption and price data.
